(19) United States
(12) Patent Application Publication
(10) Pub. No.: US 2011/0093452 A1
(43) Pub. Date: Apr. 21, 2011

(54) AUTOMATIC COMPARATIVE ANALYSIS

(75) Inventor: Alpa Jain, San Jose, CA (US)

(73) Assignee: YAHOO! INC., Sunnyvale, CA (US)

(21) Appl. No.: 12/621,439

(22) Filed: Nov. 18, 2009

Related U.S. Application Data
(60) Provisional application No. 61/253,467, filed on Oct. 20, 2009.

(51) Int. Cl. G06F 7/10; G06F 17/30

(52) U.S. Cl. 707/723; 707/769; 707/E17.014

(57) ABSTRACT

Web search engines are often presented with user queries that involve comparisons of real-world entities. Thus far, this interaction has typically been captured by users submitting appropriately designed keyword queries for which they are presented a list of relevant documents. Embodiments explicitly allow for a comparative analysis of entities to improve the search experience.

### CROSS REFERENCE TO RELATED APPLICATIONS

This application claims the benefit of U.S. Provisional Patent Application No. 61/253,467 entitled “AUTOMATIC COMPARATIVE ANALYSIS” and filed on Oct. 20, 2009, which is hereby incorporated by reference in the entirety.

### BACKGROUND OF THE INVENTION

The present invention is generally related to search engines, systems, and methods. Consumers frequently compare products or services in order to make an informed selection. For this task, consumers are increasingly relying on the Internet and on web search engines. Search engines receive many explicit queries for comparisons, such as “Nikon D80 vs. Canon Rebel XTi” and “Tylenol vs. Advil”. Several requests for comparisons, however, are implicit. For example, consider the query “Nikon D80”, which exudes an ambiguous intent: either the searcher is researching cameras (pre-buying stage), or she is ready to buy a camera (buying stage), or she is looking for product support (post-buying stage). In other scenarios, user intent may not be for a comparison although key words that are indicators for a comparison are present.

### SUMMARY OF THE INVENTION

Embodiments detect comparable entities and generating meaningful comparisons. In certain embodiments, techniques of large-scale semi-supervised information extraction are employed for extracting comparables from the Web.

Web search engines, including the associated computer systems in which they are implemented, can greatly benefit from learning comparable entities. Knowing the comparable cameras to “Nikon D80”, a search engine can then propose appropriate recommendations via query suggestions (e.g., by suggesting the query “Nikon D80 vs. Canon Rebel XTi”). From an advertisement perspective, knowing the comparables to “Nikon D80” facilitates generating a diverse set of advertisements including both, for example, sellers of “Nikon D80” and sellers of “Canon Rebel XTi”. Access to a large database of comparable entities enables a search engine to better interpret the intent behind queries consisting of multiple entities. For example, consider the query “Tilia magnolia”. Finding these two entities in the comparable database would be a strong indicator of comparison intent. Embodiments of a search system can generate a meaningful comparison between the two, and trigger a direct display illustrating a comparison chart between them.

Embodiments utilize a framework for comparative analysis and that includes automatically mining a large-scale knowledge base of comparable entities by exploiting several resources available to a Web search engine, namely query logs and a large webcrawl. One method employed is a hybrid which applies both a novel pattern-based extraction algorithm to extract candidate comparable entities as well as a distributional filter for ensuring that resulting comparable entities are distributionally similar. Embodiments analyze a collection of query logs extracted over a period of multiple (e.g. four or so) months, as well as a large webcrawl of millions of documents. Experimental analysis shows that systems in accordance with the disclosed embodiments greatly outperform a strong baseline.

One aspect relates to a method of fulfilling a search query of a user. The method comprises: receiving a portion of the search query; parsing the received portion of the query; determining if the query relates to a comparison; identifying candidate comparable items; and selecting one or more representative comparable items from the identified candidate comparable items. A further aspect relates to providing one or more query suggestions based upon the received portion of the search query, each query suggestion comprising a selected representative comparable item.

A further understanding of the nature and advantages of the present invention may be realized by reference to the remaining portions of the specification and the drawings.

### BRIEF DESCRIPTION OF THE DRAWINGS

FIG. 1 is a diagram illustrating an architecture of a query processing system and technique that provides comparative analysis.

FIG. 2 is a flow chart depicting an overview of comparables processing.

FIGS. 3A and 3B are flow charts depicting embodiments of techniques of FIG. 2.

FIG. 4 is a simplified diagram of a computing environment in which embodiments of the invention may be implemented.

FIGS. 5 and 6 are graphs illustrating precision versus rank.

### DETAILED DESCRIPTION OF THE PREFERRED EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention. All documents referenced herein are hereby incorporated by reference in the entirety.

Embodiments detect comparable entities and generating meaningful comparisons. In certain embodiments, techniques of large-scale semi-supervised information extraction are employed for extracting comparables from the Web.

Web search engines, including the associated computer systems in which they are implemented, can greatly benefit from learning comparable entities. Knowing the comparable cameras to “Nikon D80”, a search engine can then propose appropriate recommendations via query suggestions (e.g., by suggesting the query “Nikon D80 vs. Canon Rebel XTi”). From an advertisement perspective, knowing the comparables to “Nikon D80” facilitates generating a diverse set of advertisements including both, for example, sellers of “Nikon D80” and sellers of “Canon Rebel XTi”. Access to a large database of comparable entities enables a search engine to better interpret the intent behind queries consisting of multiple entities. For example, consider the query “Tilia magnolia”. Finding these two entities in the comparable database would be a strong indicator of comparison intent. Embodiments of a search system can generate a meaningful comparison between the two, and trigger a direct display illustrating a comparison chart between them.

Comparable entities are extracted from various sources, including: (a) comparison websites such as http://www.cnet.com; (b) unstructured documents such as a webcrawl; and (c) search engine query logs. Web page wrapping methods can be used to extract comparisons from comparison websites. Although high in precision, these methods require manual annotations per web host in order to train the model. Higher coverage sources, such as a full webcrawl, contain comparable entities co-occurring in documents in contexts such as lexical patterns (e.g., compare X and Y) and HTML tables. Common semi-supervised extraction algorithms from such unstructured text include distributional methods and pattern-based methods. Distributional methods model the distributional hypothesis using word co-occurrence vectors where two words are considered semantically similar if they occur in similar contexts. The word similarities typically consist of a mixed bag of synonyms, siblings, antonyms, and hypernyms. Teasing out the siblings (which often map to comparable entities) may be accomplished with clustering techniques and the associated clusters. For example, techniques and sets such as Google Sets and CBC as described in the paper entitled “Discovering word senses from text,” by P. Pantel and D. Lin in SIGKDD, 2002 may be employed. Pattern-based methods learn lexical or lexico-syntactic patterns for extracting relations between words. These are most often used since they directly target a semantic relation given by a set of seeds from the user. For example, to extract comparable entities, we may give as seeds example pairs such as comparable (Nikon D80, Canon Rebel XTi) and comparable (Tylenol, Advil).

Embodiments utilize a framework for comparative analysis and that includes automatically mining a large-scale knowledge base of comparable entities by exploiting several resources available to a Web search engine, namely query logs and a large webcrawl. One method employed is a hybrid which applies both a novel pattern-based extraction algorithm to extract candidate comparable entities as well as a distributional filter for ensuring that resulting comparable entities are distributionally similar. Embodiments analyze a collection of query logs extracted over a period of multiple (e.g. four or so) months, as well as a large webcrawl of millions of documents. Experimental analysis shows that systems in accordance with the disclosed embodiments greatly outperform a strong baseline.

### Enabling Comparative Analysis: an Overview

A comparables framework used in the disclosed embodiments employs automated methods to identify and extract comparable real-world entities with minimal human effort. Manually generating each comparable tuple is, of course, tedious and prohibitively time consuming. The framework represents not only comparable entities but also interesting relationships between entities, such as: characteristics of comparison and classes of comparison, etc. The information used by the framework captures a variety of entities as well as a variety of textual resources.

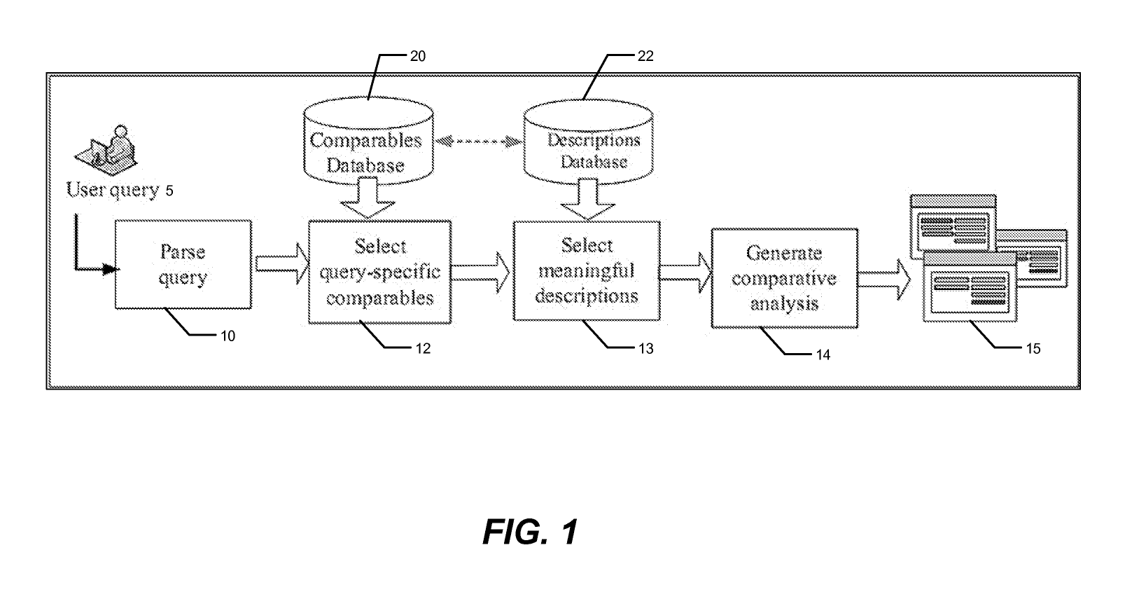

The overall architecture and methods of a query processing framework, portions of which are claimed herein, is as shown in FIG. 1. Search engine users interact with the search interface by presenting keyword queries 5 intended to (implicitly or explicitly) compare entities. Starting with a user-specified keyword query, the query execution consists of four main stages

Step (10), Parse query: An initial step is to classify whether the primary intent of the query is comparison. In one embodiment, the system employs a dictionary-based approach that uses a large collection of sets of comparables to “lookup” terms in the user query.

Step (12), Select comparables: Upon identifying an entity or list of entities mentioned in the query, a subsequent step 12 is to generate a list of comparables relevant to these entities. Embodiments may employ either an offline approach, where comparables are mined, cleaned, and well-represented in a database, e.g. comparables database 20, or use an online approach, where embodiments process only the web pages that match the user query at query execution time.

An offline approach of materializing an entire relation of comparables has some advantages. Information regarding comparables often spans a variety of sources, such as, web pages, forum discussions, query logs, and tapping into such a variety of resources at query execution time could be computationally expensive and time consuming. Additionally focusing on the information buried in the search results may be restrictive and result in incomplete information. Embodiments utilize information extraction methods which focus on automatically identifying information embedded in unstructured text (e.g., web pages, news articles, emails). As will be discussed below, information extraction methods are often noisy and require source-specific and source-independent post processing. In one embodiment, instead of providing a flat set of comparables the database 20 returns a ranked list of comparables. Oftentimes, an entity is associated with multiple comparables (e.g., in experiments, more than 50 comparables for honda civic were identified), and not all comparables may be highly relevant. Therefore, a well represented comparables database 20 preferably includes a relevance score attached to each comparable tuple.

Step (13), Select descriptions: Step 13 is an optional step present in one embodiment. Output from extraction systems, unfortunately, rarely contains sufficient information that allows consumers to fully understand the content. In the context of serving comparables, users will not only be interested in learning about comparables but also in knowing the descriptions of these comparisons. To make the results from a comparative analysis self-explanatory, in one embodiment another part of the framework focuses on providing meaningful descriptions for each pair of comparables identified. These descriptions are stored in a descriptions database 22 and may include information such as, characteristics or attributes that are common to the description of entities (e.g., resolution when comparing cameras), attributes that are not common to these entities (e.g., crime alerts when comparing vacation destinations), or reliable sources for extended comparisons (e.g., relevant forums or blogs). Just as in the case of comparables, descriptions are preferably also assigned a relevance score to identify reliable descriptions from the less reliable ones.

Step (14), Enhance search results: An additional step 14 is to enrich search results 15 by introducing comparables and descriptors from steps 12 and 13. Using state-of-the-art information extraction methods can result in significant amount of noise in the output due to the fairly generic nature of the task. Additionally, text often contains discussion on comparisons of entities along with additional information that must be eliminated to improve the quality of the comparables database. For instance, phrases involving attributes of comparison, (e.g., price, rates, gas mileage) or phrases representing the class that the entities belong to (e.g., camera in the case of Nikon d80, or car in the case of Ford Explorer) often occur in the proximity of comparable entities. Following most extraction tasks, the system identifies and distinguishes tuples with lower confidence from those with higher confidence. This task is generally carried out by exploiting some prior knowledge about the domain of the value to expect. However, in the case of comparables, entities may belong to a diverse set of domains (e.g., medicine, autos, cameras, etc.), and the system utilizes or builds filters to effectively remove noisy tuples.

In some embodiments, the system provides suggestions in the form of comparable items to aid users in formulating and completing their search task. Search assist is a technology that helps users in effectively formulating their search tasks. A comparables enabled search assist is especially useful for search tasks involving item research as users may substantially benefit from knowing other comparable items. To capture this intuition, embodiments extend the list of queries suggested to a user by providing suggestions for follow-up queries based on the comparables data. This is in addition to the existing search assist methods where extensions of the user queries are provided. As an example, in existing search systems, if a user types “Nikon d80,” traditional search assistance offers suggestions like “Nikon d80 review” or “Nikon d80 lens”; embodiments extend these suggestions to include comparables such as “canon eos xt” based on the comparable data.

### Extracting Comparables

In one embodiment mining comparables involves the usage of wrapper induction (for example as described in a paper entitled “Wrapper induction for information extraction,” by N. Kushmerick, et al. in IJCAI, 1997,) where the system creates customized wrappers to parse web pages of websites dedicated to comparisons. While wrapper induction methods are generally high in precision, they require manually annotating a sample of web pages for each web-site, and this manual labor is linear in the number of sites to process. In an alternative preferred embodiment, one of several domain-independent information extraction methods that focus on identifying instances of a pre-defined relation from plain text documents is utilized (for example, as described in the papers entitled “Snowball: Extracting relations from large plain-text collections,” by E. Agichtein and L. Gravano in DL, 2000 and “Extracting patterns and relations from the world wide web,” by S. Brin, in WebDB, 1998.)

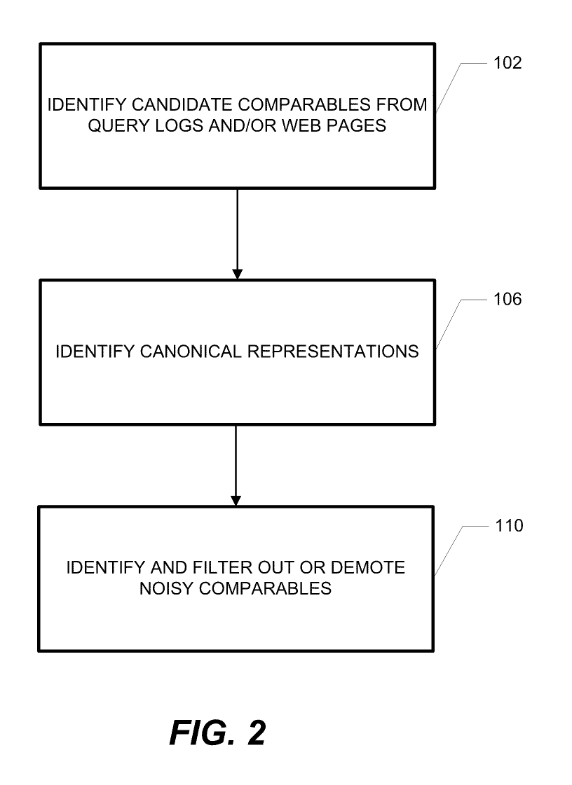

Embodiments determine a comparables relation consisting of tuples of the form (x, y), where entities x and y are comparable. FIG. 2 is a flowchart depicting comparables determination. As will be described in further detail below, in step 102 the system identifies candidate comparable pairs from web pages and query logs using information extraction techniques. In step 106, the system identifies a canonical representation for each entity in each comparable pair. Then, in step 110, the system identifies and filters out or demotes noisy comparables.

### Step 102: Pattern-Based Information Extraction

As seen in FIG. 2, in step 102, embodiments of a search engine or search provider system will identify candidate comparables by bootstrapping from queerly logs and/or web pages. Information extraction techniques employed by the disclosed embodiments automatically identify instances of a pre-defined relation from (e.g. plain text) documents. The system will apply extraction pattern based rules which are task-specific rules. Extraction patterns comprise “connector” phrases or words that capture the textual context generally associated with the target information in natural-language, but other models have been proposed (see the paper entitled “Information extraction from the World Wide Web (tutorial).” by W. Cohen and A. McCallum in KDD, 2003 for a survey of models that may be employed). To learn extraction patterns for identifying instances of comparables in web pages as well as query logs, different pattern learning methods may be employed in the same or different embodiments, namely, bootstrapped learning methods (such as that described in a paper entitled “Names and similarities on the web: Fact extraction in the fast lane,” by M. Pasca, D. Lin, J. Bigham, A. Lifchits, and A. Jain in Proceedings of ACL06, July 2006) and/or active selection pattern learning methods.

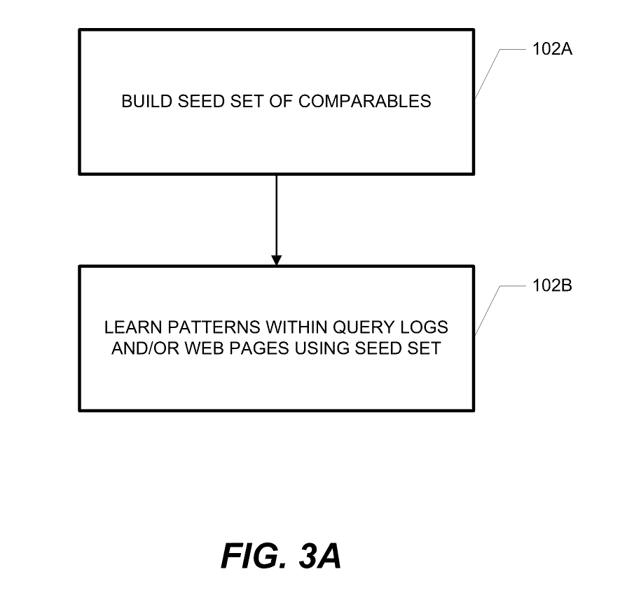

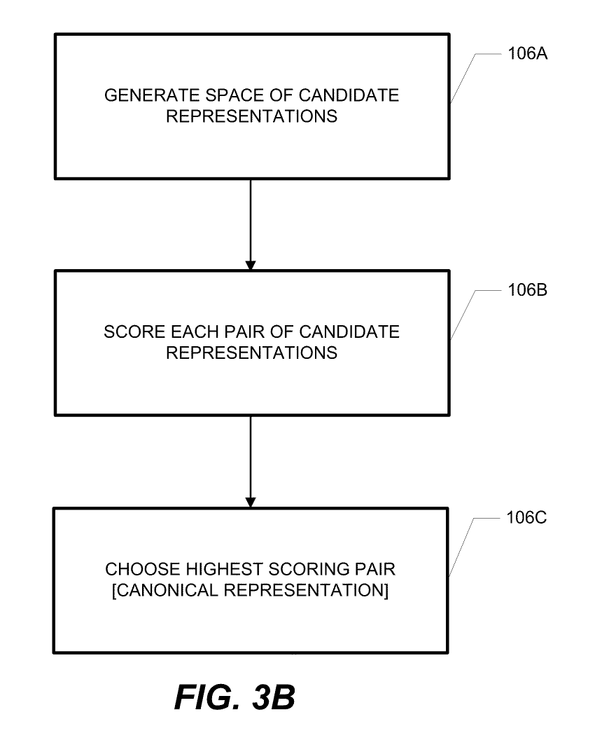

Generally speaking, step 102 may be broken down into two primary components, as seen in FIG. 3A. In step 102A the system will build a set of comparables. Then, in step 1028, the system will learn patterns (identifying candidate comparables) from query logs and/or web pages using the seed set from step 102A. Steps 102A and 102B are described in greater detail below.

Bootstrapped pattern learning: bootstrapping methods for information extraction start with a small set of seed tuples from a given relation. The extraction system finds occurrences of these seed instances in plain text and learns extraction patterns based on the context between the attributes of these instances. For instance, given a seed instance (Depakote, Lithium) which occurs in the text, My doctor urged me to take Depakote instead of Lithium, the system learns the pattern, “(E₁) instead of (E₂).” Extraction patterns are, in turn, applied to text to identify new instances of the relation at hand. For instance, the above pattern when applied to the text, Should I buy stocks instead of bonds? can generate a new instance, (stocks, bonds), after the system has appropriately identified the boundary of the entities mentioned in the text, as will be discussed below.

At each iteration, both extraction patterns and identified tuples are assigned a confidence score, and patterns and tuples with sufficiently high confidence are retained. This process continues iteratively until a desired termination criteria (e.g., number of tuples or number of iterations) is reached. Several bootstrapping methods may be employed, varying mostly in how patterns are formed and unreliable patterns or tuples are identified and filtered out. As an example, bootstrapping methods described in the following articles may be employed: Agichtein (see above Agichtein, 2000); “A probabilistic model of redundancy in information extraction” by D. Downey, O. Etzioni, and S. Soderland in Proceedings of IJCAI-05, 2005; and “Espresso: leveraging generic patterns for automatically harvesting semantic relations,” by P. Pantel and M. Pennacchiotti in Proceedings of ACL/COLING-06, pages 113-120. Association for Computational Linguistics, 2006.]. In one implementation, the bootstrapping algorithm proposed by Pasca et al. (see above, Pasca, 2006) is employed, which is effective for large-scale extraction tasks and promotes extraction patterns with words indicative of the extraction task at hand. For instance, when extracting a person-born-in relation words, the system boosts patterns that contain terms, such as, birth, born, birth date. Using this bootstrapping method, an example of patterns that were learned are:

TABLE 1
Sample patterns learned using bootstrapping;
E₁ and E₂ stand for comparable entities.

| | | | |
|---|---|---|---|
| p1: | (E1) vs. (E2) | p6: (E1) | is better than your (E2) |
| p2: | (E1) versus (E2) | p7: (E1) | compared to the (E2) |
| p3: | (E1) instead of (E2) | p8: (E1) | to (E2) |
| p4: | (E1) will beat (E2) | p9: (E1) | or (E2) |
| p5: | (E1) compared to (E2) | p10:(E1) | over (E2) |

While these patterns effectively capture the comparison intent, the resulting output can be fairly noisy due to several reasons. First, generic patterns such as p₁₀ tend to match a significant fraction of sentences in a text collection, and thus, result in a large number of incorrect tuples. For example, applying p₁₀ to the text . . . jumped over the fence . . . would generate an invalid tuple. Second, lack of prior knowledge about what to expect as an entity further exacerbates the problem. Despite the issue of generic patterns, bootstrapping methods have been successfully deployed for tasks such as, extracting person-born-in, company-CEO, or company-headquarters relations. As the attribute values in such relations are homogeneous, noisy tuples can be potentially identified using named-entity taggers that can identify instances of a pre-defined semantic classes (e.g., organizations, people, location). This, in turn, allows for verifying if values for say the company attribute in a company-CEO relation is an organization or not. In contrast, the attribute value in our comparables relation may belong to a variety of target semantic classes: for instance, the tuples, (tea, coffee), (DSL, cable), and (magnolia, Tilia), are all valid instances of the comparables relation, but the values tea, DSL, and magnolia belong to different semantic classes. Due to the iterative nature of this learning process, the quality of the output may deteriorate after a small number of iterations.

To alleviate this problem of noisy tuples, embodiments identify unreliable tuples early in the iterative process. While in one embodiment, an active learning framework where humans intervene at each iteration and suggest tuples to be eliminated, may be employed, in other embodiments, instead of identifying noisy tuples, the computer system automatically prunes out patterns that are likely to generate many noisy tuples. The latter technique is less cumbersome than manually annotating each candidate tuple.

Active selection pattern learning: The rationale behind this approach is that although humans find it difficult to recommend or generate patterns for a task, they are generally good at identifying good patterns from bad. With this in mind, in one embodiment the top-N ranking patterns are presented to a human that will select a subset of patterns. As humans are requested to choose from extraction patterns already verified to exist in text, they are likely to generate reliable tuples. Certain embodiments may utilize a subset of extraction patterns generated by a bootstrapping method.

To summarize, extraction methods are employed and in certain embodiments extended using active selection to learn patterns to generate comparables. Results extraction methods are run on at least two different types of sources, e.g., web pages and query logs.

### Step 106: Identifying Canonical Representations

Upon generating the candidate comparable pairs, as will be discussed below, in step 106 the system identifies canonical representations for the entities. Textual data is often noisy or contains multiple non-identical references to the same entity, and therefore, generally text-oriented tasks are utilized to perform data cleaning. In order to more accurately and reliably identify comparables, data cleaning is undertaken as also discussed below. Step 106 in FIG. 2 is broken down into some broadly described steps 106A-106C in FIG. 3B. In step 106A, the system generates a space of candidate representations. Then in step 106B, the system will score each pair of candidate representations. In step 106C, the system will then choose the highest scoring pair from the candidates and this will be used as a canonical representation. Embodiments of steps 106A-106C are described in more detail below.

Appropriately identifying entity boundaries is an important step in automated, information extraction. Consider the case of processing the text, I prefer tea versus coffee using pattern p₂ in Table 1, where after matching the pattern the system identifies a correct representation of the entities to be included in the final tuple. Specifically, this text can result in tuples, such as, (tea, coffee), (prefer tea, coffee), or (I prefer tea, coffee).

Exemplary candidate representation routine

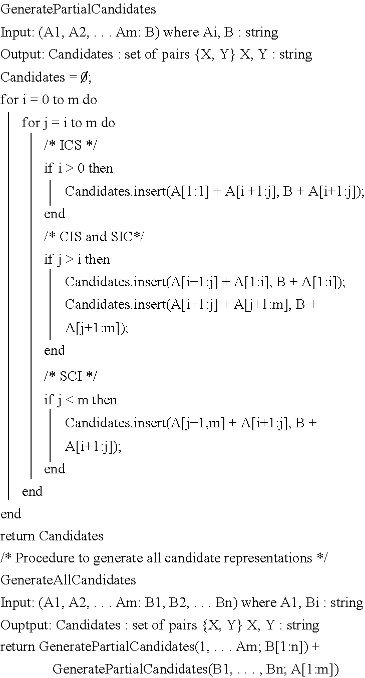

For text documents such as web pages, boundary detection is used to preprocess the text using a named-entity tagger (e.g., tag instances of pre-defined set of classes such as, organizations, people, location) or using a text chunker (e.g., tag noun, verb, or adverbial phrases) such as Abney's chunker (as described in an article entitled “Parsing by Chunks” by Steven Abney in: Principle-Based Parsing by Robert Berwick, Steven Abney and Carol Tenny (eds.), Kluwer Academic Publishers, Dordrecht. 1991.)

Certain embodiments use a text chunker to minimize the impact of and allow for arbitrary phrases in a comparables relation. Specifically, web pages are preferably processed using a variant of Abney's chunker. The phrases in a given chunk are then used as an entity when generating a tuple.

Query logs on the other hand do not yield to text chunkers due to their free-form textual format. Furthermore, the terseness of queries where only keywords are provided is challenging To understand the data cleaning issues when processing query logs, consider the following examples observed in experiments:

c₁: Nikon d80 vs. d90

c₂: 15 vs. 30 year mortgage calculator

The above examples underscore two important points: (a) generally, phrases that are common to both entities are specified only once (e.g., Nikon in c₁); (b) queries may contain extraneous words that need to be eliminated to generate a clean representation (e.g., calculator in c₂).

Consider a comparable pair P={x,y}. To construct a canonical representation for P, the system first generates a search space of candidate representations for both x and y and picks the most likely representations for both entities combined. Specifically, given a candidate representation γₓ, γ_{y}, for P, we assign a score R(γₓ) to −γₓ and a score R(γ_{y}) to γ_{y}, and pick the values for γₓ, γ_{y}, that maximizes the following:

$$〈 {γ}_{x} , {γ}_{y} 〉 = \frac{argmax \{ R ( γ x ) \cdot R ( {γ}_{y} ) \}}{\{ {γ}_{x} , {γ}_{y} \}} \qquad ( 1 )$$

To compute the score R(γᵢ) of a representation γᵢ, we observe that this score should be high for a well-represented entity. For example, for c₁, R(Nikon d90)>R(d90) and similarly for c₂ R(15)<R(15 year mortgage) but R(15 year mortgage)>R(15 year mortgage calculator).

TABLE 2
Search space of representations {γ_{x,} γ_{y}} for pair
(15, 30 year mortgage calculator) for two cases.

| Case | I | C | S | γₓ | γ_{y} |
|---|---|---|---|---|---|
| ICS | 30 | year | mortgage | 15 year | 30 year |
| | | | calculator | | |
| | 30 | year mortgage | calculator | 15 year mortgage | 30 year mortgage |
| | 30 | year mortgage | | 15 year mortgage | 30 year mortgage |
| | | calculator | | calculator | calculator |
| | 30 year | mortgage | calculator | 15 mortgage | 30 year mortgage |
| | 30 year | mortgage | | 15 mortgage | 30 year mortgage |
| | | calculator | | calculator | calculator |
| | 30 year | calculator | | 15 calculator | 30 year mortgage |
| | mortgage | | | | |
| | 30 year | | calculator | 15 | 30 year mortgage |
| | mortgage | | | | |
| | 30 year | | | 15 | 30 year mortgage |
| | mortgage | | | | calculator |
| | calculator | | | | |
| SIC | 30 year | | | 15 | 30 year mortgage |
| | mortgage | | | | calculator |
| | calculator | | | | |
| | year | mortgage | 30 | 15 mortgage | year mortgage |
| | | calculator | | calculator | calculator |
| | year | calculator | 30 | 15 year mortgage | year mortgage |
| | mortgage | | | | calculator |
| | mortgage | | 30 year | 15 mortgage | mortgage |
| | calculator | | | calculator | calculator |
| | mortgage | calculator | 30 year | 15 mortgage | mortgage |
| | | | | | calculator |
| | calculator | | 30 year | 15 calculator | calculator |
| | | | mortgage | | |

Embodiments derive the representation score as the fraction of queries that contain a representation in a stand-alone form, i.e., query is equal to the representation. Intuitively, users are more likely to search for “Nikon d90” than “d90.”

We now turn to the issue of generating a search space of representations for a pair P. Instead of considering combinations of terms in the query string in a brute-force manner, embodiments factor in that the query strings involving comparable pairs consist of three main sets: (a) a class C, (b) an instance I, and (c) a suffix S. For example, for c₂ I={15 year}, C={mortgage}, S={calculator}; similarly for c₁, S={ }, I={d90}, C={ }. Furthermore, of all six (3^{!}) possible permutations of these sets only four permutations are likely to be used to form queries. Specifically, the embodiments will use only the following four cases: ICS; CIS; SIC; and SCI. The embodiments will thus eliminate cases ISC and CSI where the instance and class are not juxtaposed. As final canonical representations, in some embodiments the system will rewrite both strings x and y in P in the form IC.

Given a candidate pair P={x, y}, we explore the space of representations as follows (see Table 2): holding one of the strings (x or y) constant, we construct all possible strings for C using the four cases listed above. Each value for C is appended (or prefixed) to the other string that has been held constant. This process is repeated vice versa for the other string. As a concrete example, Table 2 shows examples of representations for c₂.

To summarize, embodiments explore a space of candidate representations for a given pair and pick as the canonical representation the case which maximizes the representation scores for both entities combined.

### Step 110: Distributional Similarity Filters

As another step towards a well-represented comparables database, embodiments check if each comparable pair consists of entities that broadly belong to the same semantic classes. For example, while (Ph.D., MBA) is composed of valid comparables, (Ph.D., Goat) is not. To support our goal of allowing arbitrary semantic classes to be represented in the comparables relation, we employ methods to identify semantically similar phrases on a large scale. Specifically, embodiments employ distributional similarity methods (for example as discussed in the paper entitled “Automatic retrieval and clustering of similar words” by D. Lin in Proceedings of ACL/COLING-98, 1998) that model a Distributional Hypothesis (e.g. as discussed in an article entitled “Distributional structure” by Z. Harris in Word, 10(23):146-162, 1954.) The distributional hypothesis links the meaning of words to their co-occurrences in text and states that words that occur in similar contexts tend to have similar meanings.

In practice, distributional similarity methods that capture this hypothesis are built by recording the surrounding contexts for each term in a large collection of unstructured text and storing them in a term-context matrix. A term-context matrix includes weights for contexts with terms as rows and context as columns, and each cell x, j is assigned a score to reflect the co-occurrence strength between the term i and context j. Methods differ in their definition of a context (e.g., text window or syntactic relations), or in their means to weigh contexts (e.g., frequency, tf-idf, pointwise mutual information), or ultimately in measuring the similarity between two context vectors (e.g., using Euclidean distance, Cosine, Dice). One embodiment builds a term-context matrix as follows. The system processes a large corpus of text (e.g., web pages in one case) using a text chunker. Terms are all noun phrase chunks with some modifiers removed; their contexts are defined as their rightmost and leftmost stemmed chunks. The system weighs each context f using pointwise mutual information. Specifically, it constructs a point-wise mutual information vector PMI(w) for each term was: PMI (w)=(pmi_{w1}, pmi_{w2}, • • •, pmi_{wm}), where pmi_{wf} is the pointwise mutual information between term w and feature f and is derived as:

$${pmi}_{wf} = log ( \frac{{c}_{wf} \cdot N}{{\sum }_{i = 1}^{n} {ci}_{f} \cdot {\sum }_{j = 1}^{m} {c}_{wj}} ) \qquad ( 2 )$$

where c_{wf} is the frequency of feature f occurring for term w, n is the number of unique terms, m is the number of contexts, and N is the total number of features for all terms. Finally, similarity scores between two terms are computed by computing a cosine similarity between their pmi context vectors.

As an example of the similar terms, the distributional thesaurus generated by Lin [see above, Lin 1998], processed over Wikipedia, results in the following similarities for the word tea: coffee, lunch, soda, drinks, beer . . . . While distributional similarity methods can potentially generate comparables, their output also consists of a mixed bag of several semantic relations such as synonyms, siblings, antonyms, and hypernyms. For example, the distributional thesaurus above results in the following similarities for the word Apple: pear, strawberry, Microsoft, Nintendo, company . . . . Only Microsoft in this list would be considered a valid comparable entity. It is noteworthy that the output may contain phrases such as company which may be distributionally similar to Apple, but is not considered a valid comparable.

Most comparable entities fall under a sibling relation, however teasing these out from a distributional similarity output is difficult. Instead, embodiments rely on a distributional thesaurus to filter the output of relation learning methods, in order to generate a comparables relation. In particular, for each comparable pair (x, y), the system checks if y exists in the list of similar terms for x or vice versa and eliminate all pairs for which the comparable was not found in this list of similar terms. Alternatively, these scores can also be used to demote invalid pairs instead of filtering them out.

The discussion above focused mostly on a flat list of comparables, i.e., it did not consider the relevance score of a comparable. In one embodiment the system scores a comparable pair, while accounting for scores from the canonical representation and filtering steps. Using a simple frequency-based approach where the number of times a comparable pair was queried works well. Aggregating over several independently issued queries can effectively capture the relevance of a comparable.

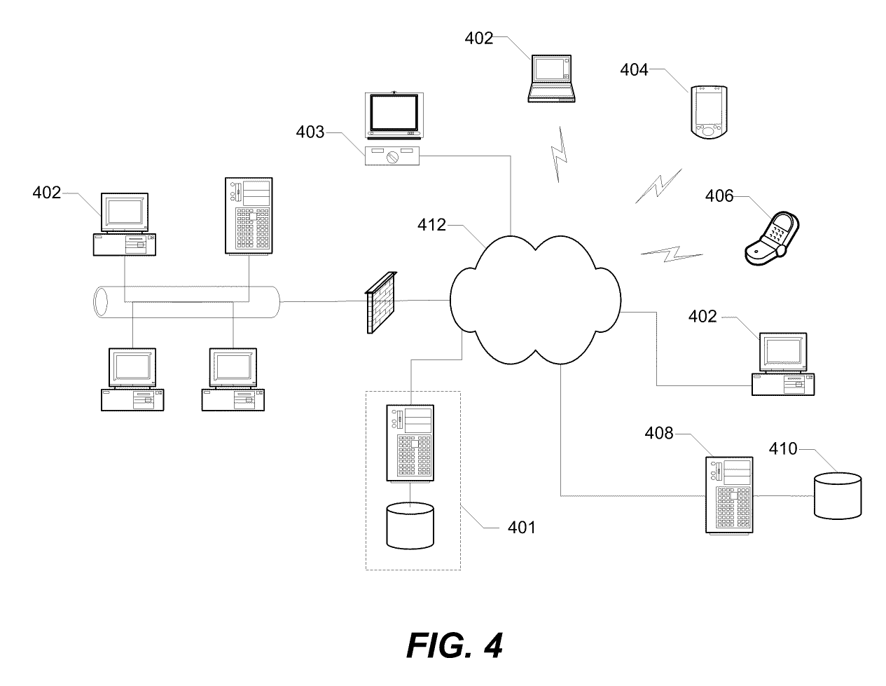

Regardless of the nature of the search service provider, searches may be processed in accordance with an embodiment of the invention in some centralized manner. This is represented in FIG. 4 by server 408 and data store 410 which, as will be understood, may correspond to multiple distributed devices and data stores. The invention may also be practiced in a wide variety of network environments including, for example, TCP/IP-based networks, telecommunications networks, wireless networks, public networks, private networks, various combinations of these, etc. Such networks, as well as the potentially distributed nature of some implementations, are represented by network 412.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

### Experimental Results

### Data Collection

Data sources: We used the following data sets as sources for finding comparable entities: Web documents (WB) A collection of 500 million web pages crawled by a commercial search engine crawl (reference suppressed).

Query logs (QL) A random sample of 100 million, fully anonymized queries collected by a search engine (reference suppressed) in the first five months of 2009. Of these queries, a 5000 query subset was separated and used as a development set to select a diverse collection of popular entities.

Extraction methods: For our experiments, we combined the bootstrapped pattern-learning and active selection algorithms with the two datasets introduced above to generate four techniques in all. We denote each of our systems using a two-letter prefix denoting the dataset (WB=web documents; QL=query logs) and a two-letter suffix denoting the extraction method (BT=bootstrapped pattern-learning; AS=active selection). We further generated two variants for each method by turning the distributional filtering stage on and off, denoted by FL when on.

Baseline: Several databases of semantically related words have been collected. Arguably the most well known is Google Sets, which returns a broad-coverage ranked ordering of terms semantically similar to a set of queried terms. We use Google Sets as our baseline by issuing each entity in our test set and extracting the list of ranked entities output by the system. We denote this technique as GS.

TABLE 3
Total number of comparables generated by each method.

| Method | Nr. of comparables |
|---|---|
| QL-AS | 4,591,343 |
| WB-AS | 7,146,982 |
| WB-BT | 1,243,121 |
| QL-BT | 2,657 |

This results in the following extraction systems:
QL-BT: Bootstrapped pattern-learning over query logs;
QL-BT-FL: Bootstrapped pattern-learning over query logs with distributional filtering;
QL-AS: Active selection over query logs;
QL-AS-FL: Active selection over query logs with distributional filtering;
WB-BT: Bootstrapped pattern-learning over 500-million document Web crawl;
WB-BT-FL: Bootstrapped pattern-learning over 500-million document Web crawl with distributional filtering;
WB-AS: Active selection over 500-million document Web crawl;
WB-AS-FL: Active selection over 500-million document Web crawl with distributional filtering; and
GS: Our strong baseline using Google Sets.

Table 3 lists the sizes of the relations generated by each method without the distributional filter and Table 4 lists some example comparables generated using QL-AS.

Distributional similarity filters: We construct our distributional similarity database by adopting the methodology proposed in “Web-scale distributional similarity and entity set expansion,” by P. Pantel et al., in Proceedings of EMNLP-09, 2009. We POS-tagged our WB corpus (500-million documents) using Brill's tagger as discussed in the article “Transformation-based error-driven learning and natural language processing: A case study in part of speech tagging,” in Computational Linguistics, 21(4), 1995 and chunked it using a variant of the Abney chunker (see above Abney, 1991.)

### Evaluation Metrics

We evaluate the performance of each system using set-based measures, i.e., precision and recall, as well as using rank retrieval measures, i.e., normalized discounted cumulative gain (NDCG) and average precision. These metrics are commonly used in information retrieval and are defined as:

Recall: Given an entity and a list L of comparables for it, we compute recall

$$\frac{\vert L ⋂ G \vert}{\vert G \vert}$$

where G is a list of ideal comparables for the entity.

Precision: Given an entity and a list L of comparables for it, we compute precision as Number of correct entries in

$$\frac{Number of correct entries in L}{\vert L \vert} .$$

Additionally, we also study the precision values at varying ranks in the list.

Average precision (AveP): Average precision is a summary statistic that combines precision, relevance ranking, and recall.

$$AveP ( L ) = \frac{{\sum }_{i = l}^{\vert L \vert} P ( i ) \cdot isrel ( i )}{{\sum }_{i = l}^{\vert L \vert} isrel ( i )} \qquad ( 3 )$$

where P(i) is the precision of L at rank i, and isrel(i) is 1 if the comparable at rank i is correct, and 0 otherwise.

Normalized Discounted Cumulative Gain (NDCG): NDCG is also commonly used to measure the quality of ranked query results. NDCG examines the fact that ideally, we would like to see good results at early rank positions, and poor quality results at lower rank positions. For a given rank R, NDCG is computed as:

$$N D C G = λ \cdot {\sum }_{i = 1}^{R} \frac{{2}^{g ( i ) - 1}}{log ( i = 1 )} \qquad ( 4 )$$

where g(i) is the grade (e.g., 10 for a perfect result, 5 for an average result, etc.) assigned to the result at rank i and λ is a normalization constant computed as the

$${\sum }_{i = 1} R \frac{{2}^{g} ( i )}{log ( i = 1 )}$$

for a list generated by sorting the results in the order of best possible grades.

TABLE 4
Sample comparables generated using
extraction methods over query logs.

| Entity | Comparables |
|---|---|
| 15 year | 30 year mortages |
| mortgages | |
| 401k | ira, pension, sep ira, 457 plan, simple ira, |
| | saving, money market funds |
| basement | crawlspace, cellar, attic |
| density | weight, volume, mass, hardness, temperature, |
| | specific gravity |
| plastic bags | paper bags, canvas, cotton bags |
| sod | grass, seeds, reseeding, artificial grass |
| solar panels | wind mill, geothermal, fossil fuels, wind turbines, |
| | solar shingles |
| stocks | corporate bonds, etf, small cap stocks, equities, |
| | currency, commodities, bonds in 401k |
| termite | flying ant, worms, formosan termites, ant flies |
| vinegar | hydrogen peroxide, sodium chloride solution, salt, |
| | ascorbic acid, mouthwash, borax, alcohol, ammonia |

### Evaluation Methodology

We split our evaluation in two parts, a target-domain evaluation and a open-domain evaluation.

Target-domain evaluation: Our target-domain evaluation focuses on an in-depth evaluation of various methods for a pre-defined set of entity classes. Due to the tedious nature of evaluation of extraction tasks, we restrict ourselves to five generic classes of entities, namely, Activities (ACT), Appliances (APP), Autos (AUTOS), Entertainment (ENT), and Medicine (MED). For each domain, we picked five frequently queried entities using the query logs training set. Table 5 shows these five categories along with the entities for each domain that we used in target-domain evaluation.

We conducted two user studies, consisting of 7 participants, to evaluate the quality of results generated by a given method. Our first user study requested a gold set of comparables from participants. Given an entity in a domain, participants provided two distinct comparables that they deem to be relevant to the entity. If the entity or the domain was previously unknown to a participant, we allowed the participant to conduct a research on the Web and provide an informed comparable. As an example, for Nikon d80, users provided comparables such as, Canon rebel xti, Nikon d200, Fujifilm Finepix z100, etc. Our second user study requested users to judge the quality of the comparables on a three-point grades scale. Starting with an entity, we generated a ranked list of top-5 comparables from each system to be evaluated. We took a union of these lists and presented it to each participant. Participants were asked to rate each comparable in the list as G for good, F for fair, or B for bad. Each user was requested about 350 annotations, and overall, our user study yielded 2,450 annotations.

Table 6 shows the inter-annotator agreement measured using Fleiss's kappa as discussed in the book Applied Statistics, by J. P. Marques De S'a, Springer Verlag, 2003. Typically, a kappa value between 0.4 and 0.6 indicates a moderate agreement between the participants. We manually examined each of the judgments and traced most of the disagreement between participants to cases where judgments were either marked F or B. We observed higher kappa values (indicating substantial agreement) for cases marked as G, indicating a consensus in what should be displayed as results for comparative analysis. For each entity, we picked a final grade based on the majority opinion of the judgments, and in case of disagreement, we requested an additional judgment.

TABLE 6
Kappa measure of interannotator agreement for each category.

| Category | Fleiss kappa |
|---|---|
| ACT | 0.53 |
| APP | 0.50 |
| AUTOS | 0.41 |
| ENT | 0.54 |
| MED | 0.42 |

Using the annotations provided by the participants, we generated another gold set of graded comparables which was, in turn, used to compute the NDCG values for each system. Furthermore, we also computed the precision at varying rank and average precision of each list by assigning a score of 1 to all comparables that were marked G and a score of 0 to the rest. It is noteworthy that all comparables graded as fair were also assigned a score of 0.

Open-domain evaluation: Our open-domain evaluation moves away from a target domain and examines the quality of comparables using a random sample of the output generated by each system. Specifically, we draw a sample of pairs of comparables generated by each method, verify them, and study the precision and nature of errors for each method.

### Experimental Results

### Target-Domain Evaluation

Recall: Our first experiment was to measure the extent to which each method identifies comparables desired by our user study participants. For each entity in our test set (see Table 5), we generated a ranked list of comparables for each method (i.e., QL-AS, WB-AS, WB-BT, • • •) and computed the recall of these lists. Table 7 compares the recall of all eight methods against that of GS, and the boldfaced numbers mark the techniques with highest recall value for a domain. QL-AS exhibits highest and QL-AS-FL exhibits close to highest values for recall, suggesting query logs as a comprehensive source for generating comparables.

TABLE 5
Sample 25 entities evaluated for the target-domain evaluation.

| Domain | Entities |
|---|---|
| ACT | dental implants, bahamas, swimming, mba, apartment |
| APP | whirlpool, nikon d80, canon eos 450d, ipod, mac |
| AUTOS | honda accord, ford explorer, toyota camry, bmw, honda civic |
| ENT | britney spears, angelina jolie, obama, new york yankees, the |
| | simpsons |
| MED | tylenol, ritalin, ibuprofen, vicodin, claritin |

We now examine the effect of introducing the filtering step. In our experiments, we observed that the overall quality of the output lists substantially improved when using the distributional thesaurus as a filter. As a concrete example, for the entity britney spears the comparables generated by WB-AS included, paris hilton and bff paris hilton (bff=“best friends forever”). Interestingly, the phrase bff paris hilton occurs frequently enough to be ranked higher, and furthermore, our canonical representation generation method also finds enough support for this entity. The filtering method on the other hand, eliminates this entity. To show the improvements by using a filter, we compare the fraction of gold set entities that were returned among the top-10 comparables returned by each method. Intuitively, a good system should return these entities early on. Table 8 shows the percentage of gold set comparables found in top-10 results for each method, averaged over all domains. For QL-BT, we observe an increase in the percentage of gold set comparables that are covered when using a filter, with the exception of the case we discussed above. This indicates that the filtering step effectively demotes noisy tuples and, in turn, boosts the ranks for reliable comparables. In case of WB-BT, we observe a relatively small improvement for a few cases. The lowest performing methods QL-BT and WBBT are more sensitive to the filter due to the already small values of recall. For the rest of the discussion, we focus on the competing methods, namely, QL-AS-FL, WB-BT-FL, WBAS-FL, and GS.

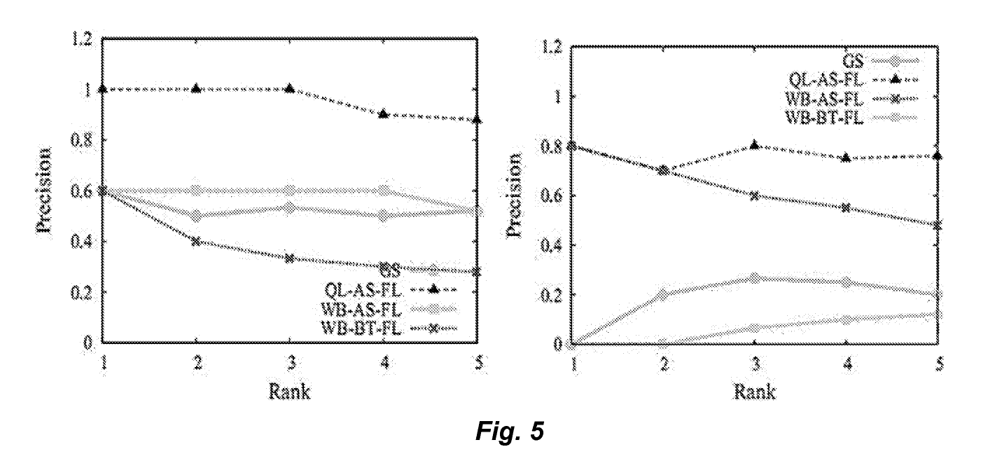

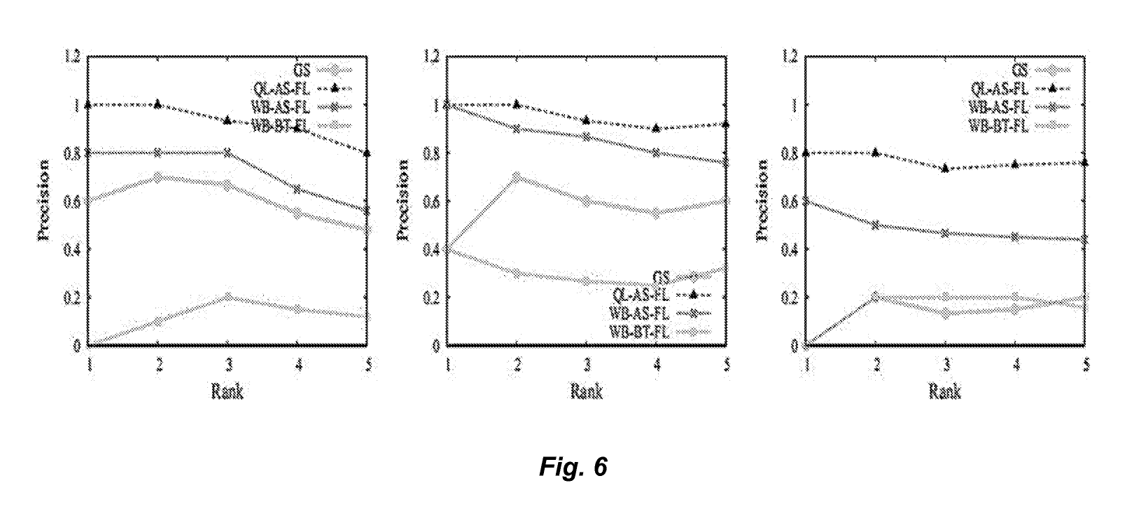

Rank order precision: We now examine the accuracy of each technique in terms of precision. FIGS. 5 and 6 show the precision for each system at varying rank, for each domain, averaged across all entities in a domain. Across a variety of domain, QL-AS-FL results in a perfect precision (precision=1.0) or close to perfect precision. The less than perfect precision for APP, can be explained by an example case of nikon d80: the system returned canon as a comparable entity at rank 1, which was graded as F by our annotators. Recall that we treat all entities graded F to be incorrect when computing the precision. All the other comparables generated for this entity were marked G. We discuss such cases where an instance of a class is compared against a class later in this section. Comparing WB-AS-FL and WB-BTFL we observe that using active selection to identify reliable patterns results in substantially improving the performance of an extraction method for the same source. As seen in FIGS. 5 and 6, both QL-AS-FL and WB-AS-FL consistently outperform GS, across all domains.

TABLE 7
Average recall for each method, for each category,
measured using a user-provided gold set.

| Method | ACT | APP | AUTOS | ENT | MED |
|---|---|---|---|---|---|
| GS | 0.37 | 0.32 | 0.50 | 0.62 | 0.47 |
| QL-AS | 0.77 | 0.90 | 0.87 | 0.95 | 0.90 |
| WB-AS | 0.55 | 0.37 | 0.40 | 0.58 | 0.52 |
| QL-BT | — | 0.22 | 0.03 | 0.02 | 0.10 |
| WB-BT | 0.07 | 0.12 | 0.03 | 0.20 | 0.22 |
| QL-AS-FL | 0.62 | 0.35 | 0.78 | 0.72 | 0.85 |
| WB-AS-FL | 0.33 | 0.22 | 0.40 | 0.43 | 0.52 |
| QL-BT-FL | — | 0.13 | 0.03 | — | 0.02 |
| WB-BT-FL | 0.05 | 0.05 | — | 0.07 | 0.12 |

TABLE 8
Average percentage of user-provided gold sets that were
identified in top-10 results returned by each system.

| Method | ACT | APP | AUTOS | ENT | MED |
|---|---|---|---|---|---|
| GS | 34 | 54 | 60 | 72 | 54 |
| QL-AS | 56 | 82 | 62 | 64 | 84 |
| WB-AS | 58 | 56 | 46 | 58 | 58 |
| QL-BT | — | 5 | 4 | 2 | 12 |
| WB-BT | 4 | 26 | 2 | 18 | 26 |
| QL-AS-FL | 76 | 48 | 68 | 70 | 94 |
| WB-AS-FL | 58 | 56 | 66 | 56 | 62 |
| QL-BT-FL | — | 4 | 4 | — | 2 |
| WB-BT-FL | 2 | 26 | — | 18 | 14 |

Table 9 compares NDCG@5 values for each method, across all entities and target domains. t marks NDCG values that are a statistically significant improvement over the baseline of GS. Both QL-AS-FL and WB-AS-FL exhibit a significant improvement of 30% and 20% gain, respectively, over the existing approach of using Google Sets. Table 10 shows the NDCG@5 values for each of the five target domains. Interestingly, for the domain of ACT, using an approach based on related words as in the case of GS, proves to be undesirable. This confirms our earlier observations that using distributional similarity-based methods suffer from being too generic for the task of comparables. As a specific example, for the entity apartment, GS generates the following comparables, 1 bathroom, washing machine, 2 bathrooms which were consistently graded as B by all participants in our user studies. In contrast, QL-AS-FL generates comparables, such as, condominium, house, townhouse which were graded as G by our participants. We examined values for NDCG@10 and observed similar results.

TABLE 9
Average NDCG@5 over all categories, measured using a three-
point grade. (t indicates statistical significance over GS.).

| Method | NDCG@5 |
|---|---|
| GS | 0.67 ± 0.11 |
| QL-AS-FL† | 0.96 ± 0.03 |
| WB-AS-FL† | 0.86 ± 0.06 |
| QL-BT-FL | 0.54 ± 0.12 |

TABLE
Average NDCG@5 for each category,
measured using a three-point grade.

| Category | ACT | APP | AUTOS | ENT | MED |
|---|---|---|---|---|---|
| GS | 0.35 | 0.51 | 0.85 | 0.85 | 0.80 |
| QL-AS-FL | 0.93 | 0.91 | 0.99 | 1.00 | 0.99 |
| WB-AS-FL | 0.81 | 0.77 | 0.86 | 0.93 | 0.97 |
| QL-BT-FL | 0.44 | 0.47 | 0.72 | 0.41 | 0.62 |

Table 10 compares the average precision (AveP) values for each method and t marks values that are a statistically significant improvement over GS. (Recall that AveP summarizes the precision, recall, and rank ordering of a ranked list.) Both QL-AS-FL and WB-AS-FL exhibit a significant improvement of 39% and 36% gain, respectively, over GS. As expected, QL-AS-FL exhibits highest values for AveP confirming the choice of active selection over query logs as a promising direction.

What is claimed is:

1. A method of fulfilling a search query of a user, comprising:
receiving a portion of the search query;
parsing the received portion of the query;
determining if the query relates to a comparison;
identifying candidate comparable items;
selecting one or more representative comparable items from the identified candidate comparable items; and
providing one or more query suggestions based upon the received portion of the search query, each query suggestion comprising a selected representative comparable item.

2. The method of claim 1, wherein determining if the query relates to a comparison comprises employing a dictionary-based approach to search a collection of sets of comparable items for terms in the received portion of the query.

3. The method of claim 1, wherein identifying candidate comparable items comprises extraction from query logs and web pages.

4. The method of claim 3, wherein identifying candidate comparable items further comprises building a seed set of comparables.

5. The method of claim 4, wherein identifying candidate comparable items further comprises using the seed set to learn patterns within query logs and web pages.

6. The method of claim 1, wherein selecting one or more representative comparable items comprises identifying and filtering out noisy comparable items.

7. The method of claim 1, wherein selecting one or more representative comparable items comprises demoting noisy comparable items.

8. The method of claim 1, wherein selecting one or more representative comparable items comprises generating a space of candidate representations.

9. The method of claim 8, wherein selecting one or more representative comparable items comprises scoring each pair of candidate representations.

10. The method of claim 9, wherein selecting one or more representative comparable items comprises choosing a high scoring pair of candidate representations.

11. A method of fulfilling a search query of a user, comprising:
receiving a portion of the search query;
parsing the received portion of the query;
determining if the query relates to a comparison;
identifying candidate comparable items; and
selecting one or more representative comparable items from the identified candidate comparable items.

12. A search query processing computer system, the system configured to:
receive a portion of the search query;
parse the received portion of the query;
determine if the query relates to a comparison;
identify candidate comparable items;
select one or more representative comparable items from the identified candidate comparable items; and
provide one or more query suggestions based upon the received portion of the search query, each query suggestion comprising a selected representative comparable item.

13. The computer system of claim 12, wherein the computer system is configured to identify candidate comparable items by extracting from query logs and web pages.

14. The computer system of claim 13, wherein the computer system is configured to identify candidate comparable items by building a seed set of comparables.

15. The computer system of claim 14, wherein the computer system is configured to identify candidate comparable items by using the seed set to learn patterns within query logs and web pages.

16. The computer system of claim 12, wherein the computer system is configured to select one or more representative comparable items by identifying and filtering out noisy comparable items.

17. The computer system of claim 12, wherein the computer system is configured to select one or more representative comparable items by demoting noisy comparable items.

18. The computer system of claim 12, wherein the computer system is configured to select one or more representative comparable items by generating a space of candidate representations.

19. The computer system of claim 18, wherein the computer system is configured to select one or more representative comparable items by scoring each pair of candidate representations.

20. The computer system of claim 19, wherein the computer system is configured to select one or more representative comparable items comprises by choosing a high scoring pair of candidate representations.
